(19) United States
(12) Patent Application Publication
(10) Pub. No.: US 2010/0099140 A1
(43) Pub. Date: Apr. 22, 2010

(54) METHODS AND COMPOSITIONS FOR PREVENTING ARTIFACTS IN TISSUE SAMPLES

(76) Inventor: Thomas M. Donndelinger, Nampa, ID (US)

Correspondence Address: KIRTON AND MCCONKIE, 60 EAST SOUTH TEMPLE,, SUITE 1800, SALT LAKE CITY, UT, 84111, US

(21) Appl. No.: 12/582,578

(22) Filed: Oct. 20, 2009

Related U.S. Application Data
(60) Provisional application No. 61/107,220, filed on Oct. 21, 2008.

(51) Int. Cl. G01N 1/30

(52) U.S. Cl. 435/40.52

(57) ABSTRACT

Methods and compositions for preventing artifacts in tissue samples fixed with an aldehyde-based fixative are described. The methods include fixing a tissue sample with an aldehyde-based fixative, such as a formalin fixative agent. After fixation, the tissue sample can be contacted with separate solutions that each contain an artifact preventing composition or a tissue stain. However, because the artifact preventing composition may increase the stain's shelf-life, the stain and the composition are preferably mixed before being added to the sample. The artifact preventing composition can include one or more amino acids, polyamines, and/or Schiff-base-forming compounds. The components of the composition can bind to or react with free fixative to prevent fixative artifacts. Additionally, reactions between the artifact preventing composition and free aldehyde-based fixative may be favorable due to the thermodynamics, small size, high ability to diffuse, and/or high concentration of the components of the artifact preventing composition.

### BACKGROUND

1. Field

This application relates generally to methods and compositions for use with fixed tissue samples. More specifically, this application relates to methods and compositions for preventing artifacts, improving staining in tissue samples that have been preserved with an aldehyde-based fixative, and increasing the useable operational life of tissue stains.

2. Background

Tissue samples may include one or more cells, tissues, organs, or other materials obtained from an organism, as well as the entire organism or a portion thereof. Such tissue samples may be useful in the study and practice of medicine, histology, pathology, cellular biology, and the biological sciences in general. For instance, tissue samples may aid in the study of diseases, disorders, functions, structures, and other characteristics of biological specimens. Although tissue samples may be obtained in many ways, including from autopsy, biopsy, surgery, necropsy, etc., once obtained, the samples are often subject to proteolytic enzymes and other processes that tend to break down and degrade biological material.

In order to preserve a tissue sample's structure or morphology, as well as to conserve the stability of proteins, tissue samples are often preserved through a process called fixation. Fixation is a chemical process that may prevent sample decay by terminating ongoing biochemical reactions. There are many fixation processes as well as reagents. For instance, tissue samples may be fixed with a cross-linking fixative, such as an aldehyde-based fixative. It is believed that aldehyde-based, cross-linking fixatives may react with proteins and other molecules in the tissue sample to form methylene bridges. The methylene bridges may produce a network of chemical bonds that can prevent the movement of large molecules, such as proteins, and substantially preserve the physical structure of the tissue sample. After fixation, destructive enzymes may be prevented from further degrading the tissue sample.

Although fixation may allow tissue samples to be studied long after acquisition and the period of time in which the natural degradation of the samples would have otherwise occurred, fixation is not without shortcomings. For instance, some aldehyde-based fixatives may cause or increase visual artifacts in stained tissue samples. In one rare example of such an artifact, under acidic conditions in a fixed tissue sample, a pigment from an aldehyde-based fixative may form. For instance, in formaldehyde fixatives, acid formaldehyde hematin, or formaldehyde pigment, may form. Formaldehyde pigment and pigments from other aldehyde-based fixatives may form a brownish colored pigment deposit in the fixed sample. Such a pigment deposit may not only be distracting, but may also prevent accurate tissue sample analysis.

In another more common example of an artifact associated with an aldehyde-based fixative, some aldehyde-based fixatives may cause cell or cell structure shrinkage. For instance, cells treated with an aldehyde-based fixative, such as a 10% formalin phosphate buffer, may shrink about 15% upon fixation. This shrinkage may distort cells and cell structures and, thereby, change cell morphology. Moreover, this cell shrinkage can also cause a diffusion barrier that prevents or impairs a tissue stain or the aldehyde-based fixative from properly entering, staining, or fixing portions of the sample.

In still another example of a potential artifact associated with aldehyde-based fixation, the network of methylene bridges formed during fixation with an aldehyde-based fixative may lessen immunoreactivity, or prevent desirable interactions between molecules in the sample and molecules that are used for analysis. For instance, methylene bridges associated with an aldehyde-based fixative may prevent antibody molecules from penetrating a sample and reaching antigens of interest during staining procedures. Therefore, proper visualization of antigens may be prevented due to physical hindrance, even though the epitopes of the antigens may not have been chemically modified. Similarly, the methylene bridges formed during fixation with an aldehyde-based fixative may prevent some tissue stains from properly binding to the sample. For instance, the methylene bridges formed during fixation may bind to the same sites as some tissue stains and thereby reduce stain binding and prevent proper visualization.

Without being bound by theory, it is believed that prolonged staining of a tissue sample that has been fixed with an aldehyde-based fixative may replicate some of the traditional aldehyde-based artifacts mentioned above. As mentioned, some stains, such as hematoxylin and eosin, may compete with the aldehyde-based fixative for binding sites in the tissue sample. Accordingly, prolonged staining with such stains may cause some of the aldehyde-based fixative to be released from the sample into solution. Once in solution, the free aldehyde-based fixative may bind again to the sample and cause additional artifacts. These artifacts may limit the effectiveness of tissue staining and visualization procedures.

Accordingly, it would be an improvement in the art to develop methods and compositions for preventing artifacts and improving staining in tissue samples prepared with aldehyde-based fixatives.

### BRIEF SUMMARY

The present invention provides novel methods and compositions for preventing artifacts in tissue samples that have been fixed with an aldehyde-based fixative. Generally, the described methods may include fixing a tissue sample with an aldehyde-based fixative, such as a formalin fixative agent. The aldehyde-based fixative may cause methylene bridges to be formed with polar amino acids and similar residues in the tissue sample. Over time, and in the presence of water, it is believed that some of these methylene bridges may naturally reverse and release aldehyde-based fixative into solution. Without being bound by theory, it is believed the presence of free aldehyde-based fixative molecules within the tissue sample may react with or interfere with tissue stains.

It is within the scope of the present invention to contact a fixed tissue sample with a composition that prevents or inhibits artifact formation. This artifact preventing composition can comprise any compound that binds to or otherwise reacts with the free aldehyde-based fixative molecules within the tissue sample in a manner that prevents the free aldehyde-based fixative from forming artifacts. For example, the artifact preventing composition can include one or more amino acids, polyamines and/or compounds that form Schiff bases when reacted with an aldehyde-based fixative.

Some non-limiting examples of suitable amino acids may include arginine, lysine, tyrosine, histidine, asparagine, glutamine, and tryptophan residues. Some non-limiting examples of suitable polyamines include polymers composed of more than one unit of a single type of amino group (“homo-polymers”) and polymers comprising more than one type of amino group (“hetero-polymers”). Accordingly, non-limiting examples of suitable polyamines include chemicals or polymers comprising polyarginine, polycysteine, polyhistidine, polylysine, putrescine, and polyethylenimine, and/or homo- or hetero-polymers of positively charged amino acids.

Under a non-binding theory, it is believed that the polyamine and/or amino acids binds to or otherwise reacts with the aldehyde-based fixative that has been released from the tissue and may, thereby, prevent or impede the fixative from binding to the tissue and/or stain to create artifacts. Under a similar non-binding theory, it is believed that the addition of one or more Schiff-base-forming compounds allow a portion, if not all, of the free fixative in the tissue to be captured by and/or react with the Schiff-base-forming compounds to form Schiff bases and, thereby, prevent or impede the free aldehyde-based fixative from reacting with the tissue sample to form artifacts. In some cases, the reactions between the free fixative, the polyamines, and/or the Schiff-base-forming compounds are thermodynamically favorable. Accordingly, the addition of one or more amino acids, polyamines, and/or Schiff-base-forming compounds can effectively prevent the free aldehyde-based fixative in the tissue sample from forming new or additional artifacts.

The fixed tissue sample may be contacted with the artifact preventing composition at any time. For example, the fixed tissue sample may be contacted with the artifact preventing composition before, after, or at the same time the tissue sample is contacted with a tissue stain solution. Similarly, the artifact preventing composition can be combined with the fixed tissue sample alone or in combination with a solution containing the tissue stain(s). In some embodiments, however, the artifact preventing composition and the tissue stain are combined together before they are contacted with the tissue sample at the same time. Indeed, because the artifact preventing composition can unexpectedly increase the tissue stain's useful shelf-life, it may be beneficial to mix the tissue stain and the artifact preventing composition together in a solution before combing a portion of the solution with the tissue sample.

### BRIEF DESCRIPTION OF THE DRAWINGS

The following description can be better understood in light of several Figures, in which:

FIG. 1 contains a photograph of a Hematoxylin and Eosin stained bone marrow sample that has not been treated with an artifact preventing composition;

FIG. 2 contains a photograph of a Hematoxylin and Eosin stained bone marrow sample that has been treated with a representative embodiment of the artifact preventing composition;

FIG. 3 contains a photograph of a Hematoxylin and Eosin stained human uterine tube tissue sample that has not been treated with the artifact preventing composition;

FIG. 4 contains a photograph of a Hematoxylin and Eosin stained human uterine tube tissue sample that has been treated with the artifact preventing composition;

FIG. 5 contains a photograph of a Hematoxylin and Eosin stained human endometrial tissue sample that has not been treated with the artifact preventing composition; and

FIG. 6 contains a photograph of a Hematoxylin and Eosin stained human endometrial tissue sample that has been treated with the artifact preventing composition.

Together with the following description, the Figures may help demonstrate and explain the principles of the described methods and compositions.

### DETAILED DESCRIPTION

The presently preferred embodiments of the described invention may be understood by reference to the following description. It will be appreciated that the described methods and compositions, as generally disclosed herein, may be arranged and designed in a wide variety of manners. Thus, the following more detailed description of the embodiments of the present invention is not intended to limit the scope of the invention, as claimed, but is merely representative of presently preferred embodiments of the invention.

This application generally discloses methods and compositions for reducing, reversing, impeding, or otherwise preventing artifacts in fixed tissue samples. More specifically, this application discloses using an artifact preventing composition to prevent artifacts and improve staining in tissue samples fixed with an aldehyde-based fixative. To better explain the described methods and compositions, this application first discusses aldehyde-based fixation and then discusses the prevention of artifacts in tissue samples fixed with an aldehyde-based fixative by contacting the samples with an artifact preventing composition.

As mentioned, an aldehyde-based fixative may be used to chemically preserve a tissue sample. Moreover, known or novel aldehyde-based fixatives of several varieties may be used as the fixative. Some examples of suitable aldehyde-based fixatives may include formaldehyde, glutaraldehyde, paraformaldehyde, and the like. Nevertheless, to better explain the use of the artifact preventing composition, this application discusses some non-limiting embodiments in which the artifact preventing composition is used in tissue samples that have been fixed with formaldehyde.

Although other known or novel formaldehyde solutions may be used to fix a tissue sample before treatment with the artifact preventing composition, formaldehyde is often described and used based upon a standardized aqueous solution of formaldehyde commonly known as formalin. Formaldehyde, at room temperature and 1 atmosphere, is a gas. However, formaldehyde is usually sold as an aqueous solution. The most common aqueous concentration used is a 37% by weight (40% by volume) solution. This solution contains 37 grams of formaldehyde gas to 100 grams of solution. When left alone in water, formaldehyde tends to polymerize. To inhibit the polymerization of a formaldehyde solution, methyl alcohol is often added up to a concentration from about 10% to about 15%, by volume. The term “formalin” is given to a solution that is about 37% formaldehyde gas, by weight, in water, usually with about 10% to about 15% methyl alcohol, by volume. A commonly used formaldehyde fixative agent may comprise about 10% formalin. Thus, a fixative agent (or a solution containing a fixative and other desired substances at a concentration appropriate for tissue sample fixation) that is about 10% formalin may contain about 3.7% to about 4% formaldehyde, by weight.

Where formalin is used as the fixative, various types of formalin or fixative agents containing formalin may be applied to a tissue sample. For example, a tissue sample may be fixed with a conventional zinc-formalin fixative agent, a formalin-acetic acid fixative agent, or a formalin-alcoholic fixative agent. As is known in the art, the form of formalin used may depend on the type of tissue sample being fixed as well as the desired uses of the fixed sample.

A suitable concentration of fixative may be used in a fixative agent to chemically preserve a tissue sample. Indeed, the concentration of a fixative in a fixative agent may depend on the desired application. For example, as stated, a conventional formalin fixative agent may have a concentration from about 3.7% to about 4% by weight formaldehyde. In another example, a fixative agent has a concentration of about 0.2% to about 6% by weight formaldehyde. In a presently preferred example, however, the fixative agent has a concentration from about 0.2% to about 2% by weight formaldehyde. In one non-limiting example, a formalin fixative agent has an osmolarity from about 500 milliosmolar to about 2,000 milliosmolar and preferably an osmolarity from about 500 milliosmolar to about 1,200 milliosmolar.

Nevertheless, the teachings of this disclosure may be used with various fixatives at various suitable concentrations.

An aldehyde-based fixative agent, such as a formalin fixative agent, may additionally comprise any other substance suited to the desired application of the fixative agent. For example, a fixative agent may comprise solvents (e.g., dimethyl sulfoxide (“DMSO”) and water), detergents, alcohols, buffers (e.g., a phosphate buffer), polymers, etc. Additionally, an aldehyde-based fixative agent may include any substance that may act as a stabilizer for nucleic acids, such as DNA or RNA.

A fixative agent, such as one that contains formalin and other desired substances, may be applied to a tissue sample in any suitable manner. For instance, a tissue sample may be immersed in, perfused with, sprayed with, fumigated with, or otherwise contacted with a fixative agent. In one example, a tissue sample may be completely immersed in a fixative agent for any desired amount of time. In another example, however, a fixative agent may be injected into the heart of an organism, like a zebrafish (Danio rerio), with the injection volume matching the organism's cardiac output. In this example, the fixative agent may then perfuse throughout the organism.

Furthermore, any desired method or protocol for fixation of tissue samples may be followed. An example of a fixation method is found in U.S. Utility patent application Ser. No. 11/953,670, entitled Compositions and Methods for Preparing Specimens for Microscopic Analysis, filed Dec. 10, 2007; the entire disclosure of which is hereby incorporated by reference.

A protocol for fixing a tissue sample with an aldehyde-based fixative, such as a formalin fixative agent, may involve any step or procedure that aids in the fixation of a tissue sample. For example, a tissue sample may be rinsed or washed in a variety of methods. Additionally, a protocol may require the immersion of a tissue sample in a fixative agent for any suitable amount of time. In one non-limiting example, a protocol may require that a tissue sample be immersed in a fixative agent for as little as about 30 minutes or as long as about 72 hours, or more, depending on the sample size, type, temperature of the agent, etc. A fixation protocol may also include the heating or cooling of a sample. A protocol may also require a sample to be dehydrated through a series of baths, which may incrementally increase in alcohol concentration. Moreover, a fixation protocol may also include embedding a sample in paraffin or even applying a second fixative. Indeed, the skilled artisan will recognize that a fixation protocol may involve many additional procedures. Furthermore, the skilled artisan will recognize that a tissue sample that has been fixed with an aldehyde-based fixative may be treated in any suitable way. For example, a tissue sample may be frozen, sliced by a cryostat, chilled, stored, stained, etc.

As previously mentioned, once a tissue sample has been fixed with an aldehyde-based fixative, artifacts associated with fixation may be prevented by contacting the tissue sample with an artifact preventing composition, as described herein. The artifact preventing composition is based on a non-binding theory that aldehyde-based fixatives bind and form methylene bridges with polar amino acids and similar residues in tissue samples. Methylene bridges may be formed from a methylol or a Schiff base intermediate. A methylol or Schiff base intermediate may be created upon reaction of an aldehyde-based fixative (e.g., formaldehyde) with either the N-terminal of an amino acid residue or with the amino and/or thiol groups found on lysine, arginine, cysteine, and histidine residues. The methylol and Schiff base intermediates may then react with arginine, asparagine, glutamine, histidine, tryptophan, cytosine, and/or tyrosine residues to form methylene bridges. (For a more complete discussion of methylene bridge formation through the reaction of formaldehyde with polar amino acids and similar residues in synthetic peptides, see Bernard Metz et al., Identification of Formaldehyde-induced Modifications in Proteins: Reactions with Model Peptides, 279 J. BIOL. CHEM., 6235-43 (Feb. 20, 2004)). Moreover, the chemical reactions that form methylene bridges during aldehyde-based fixation may have a tendency to reverse naturally, to some extent. For instance, when a sample that has been fixed with an aldehyde-based fixative is exposed to water, even in trace amounts, some of the methylene bridges between the fixative and the tissue may reverse and some amount of the fixative may be released into solution. Over a period of time, the gradual reversal of methylene bridges to release aldehyde-based fixative may contribute to the formation of some of the artifacts in the fixed and stained sample.

Without being bound by theory, it is presently believed the aldehyde-based fixative may be impeded or prevented from forming artifacts by contacting the tissue sample with an artifact preventing composition that comprises one or more compounds that compete and/or react with the aldehyde-based fixative in a manner that provides alternative binding or reacting opportunities for the released or free fixative. Additionally, if such compounds present more favorable binding conditions than do the polar amino acids and similar residues in the tissue sample, the formation of methylene bridges from the fixative may be thermodynamically driven in favor of these additional compounds. Such compounds may include any chemical that reacts with the aldehyde-based fixative in a manner that prevents the fixative from forming artifacts in the tissue sample. Some examples of compounds in the artifact preventing composition that bind to, compete with, and/or otherwise react with aldehyde-based fixatives may include one or more amino acids, polyamines, and/or compounds that form a Schiff base when reacted with an aldehyde-based fixative.

In some embodiments, the artifact preventing composition comprises one or more free amino acids, or amino acids that are not bound to each other to form a polymer. In such embodiments, the composition may comprise any suitable amino acid that is capable of providing an alternative binding or reaction site to free aldehyde-based fixative, or that is otherwise capable of preventing artifacts associated with an aldehyde-based fixative. Some non-limiting examples of such free amino acids may include free lysine, arginine, tyrosine residues, histidine, asparagine, glutamine, and tryptophan residues. Indeed, in some embodiments, arginine, tyrosine, and, to a lesser degree, histidine, asparagine, glutamine, and tryptophan residues may react with a Schiff base adduct formed by glycine and formaldehyde to further prevent fixative artifacts.

In some embodiments, the artifact preventing composition comprises one or more polyamines. Indeed, the composition may comprise any polyamine that may bind to an aldehyde-based fixative (e.g., formaldehyde), may provide alternative binding or reacting sites to free aldehyde-based fixative, or may otherwise prevent artifacts associated with an aldehyde-based fixative. Some non-limiting examples of polyamines that prevent artifacts in tissue samples fixed with an aldehyde-based fixative can include homo-polymers (e.g., organic polymers of a single amino-containing monomer) or hetero-polymers (e.g., organic polymers of mixed amino-containing monomers). Some non-limiting examples of homo-polymers may include polymers consisting of polylysine, polyarginine, polyethylenimine, polytryptophan, putrescine, cadaverine, spermidine, spermine, or any other suitable natural or synthesized polymer composed of a single amino group. Similarly, some non-limiting examples of hetero-polymers include polymers comprising a combination of lysine, polylysine, arginine, polyarginine, polyethylenimine, polytryptophan, putrescine, cadaverine, spermidine, spermine, and/or any other suitable natural or synthesized amino group, in any suitable combination.

Where the artifact preventing composition includes a polyamine, the polyamine may have any characteristic that allows it to prevent free aldehyde-based fixative from causing artifacts in the tissue sample. For example, the artifact preventing composition can include a polyamine of any length that allows the polyamine to bind or otherwise react with aldehyde-based fixative in solution. By way of illustration, a suitable polyamine may comprise any number of amino acid monomers or residues that allows the polyamine to bind to or otherwise react with free aldehyde-based fixative. For instance, a suitable polylysine or polyarginine may comprise between about 2 and about 1,500 lysine or arginine residues, respectively. Additionally, the artifact preventing composition may comprise a polyamine of any molecular weight that is suitable to allow the polyamine to bind to an aldehyde-based fixative. In one non-limiting example, the composition comprises a polyamine with a molecular weight greater than about 20,000 unified atomic mass units. However, in another example, the composition comprises a polyamine with a molecular weight of less than about 20,000 unified atomic mass units. In yet another example, the composition includes a polyamine with a molecular weight between about 4,000 and about 15,000 unified atomic mass units.

While some amino acids and polyamines may form Schiff bases when reacted with an aldehyde-based fixative, in some embodiments, the artifact preventing composition comprises one or more additional compounds that form Schiff bases when reacted with an aldehyde-based fixative. It is theorized that the composition comprising such Schiff-base-forming compounds may compete with or provide alternative binding and reacting opportunities for the free fixative in the tissue sample in a manner that prevents undesired artifacts. While the composition can comprise any compound that forms a Schiff base when reacted with an aldehyde-based fixative, some non-limiting examples of suitable Schiff-base-forming compounds may include glycine; arginine; aspartic acid; polyethylenimine; peptides comprising glycine, arginine, aspartic acid, polyethylenimine; and/or any other natural or synthesized compound that forms a Schiff base when reacted with an aldehyde-based fixative. Some additional non-limiting examples of Schiff-base-forming compounds may include any other amino acid that forms a Schiff base when it reacts with formaldehyde.

Where the artifact preventing composition includes a peptide comprising a Schiff-base-forming compound (e.g., glycine, arginine, aspartic acid, and/or polyethylenimine), the peptide may be natural (e.g., be a protein or a portion thereof) or be synthesized. Additionally, the peptides comprising a Schiff-base forming compound may be homopeptides comprising only a single type of Schiff-base-forming compound and/or the peptides may be heteropeptides comprising more than one type of Schiff-base-forming compound. In another example, the amino groups in the peptide may be in any combination that is suitable to prevent artifacts in tissue samples fixed with an aldehyde-based fixative. In still another example, the peptide may be any length. For instance, the peptide may be as short as about 2 amino acids or as long as about 2,000 amino acids, or more. However, in some instances, the peptide ranges in length from about 5 to about 200 amino acids. In other instances, the peptide ranges in length from about 10 to about 50 amino acids. In still other instances, the composition comprises multiple peptides of a variety of lengths.

The artifact preventing composition may include any combination of chemicals or compounds that bind to, or react with, free aldehyde-based fixative to prevent artifacts in a tissue sample that has been fixed with an aldehyde-based fixative. Indeed, in some embodiments, the composition comprises one or more types of polyamines. For example, the composition can comprise polylysine, polyarginine, or both. In other embodiments, however, the composition comprises one or more Schiff-base-forming compounds. For example, the composition can comprise glycine; arginine; aspartic acid; polyethylenimine; and/or peptides comprising glycine, arginine, aspartic acid, and/or polyethylenimine. In some preferred embodiments, the composition comprises at least one polyamine and at least one Schiff-base-forming compound. In such embodiments, the composition may comprise any suitable number or combination of polyamines and Schiff-base forming compounds. In one example, the composition comprises a mixture of two or more of polylysine, polyarginine, asparagine, glycine, and polyethylenimine. In another example, the composition comprises polylysine and glycine. In still another example, the composition comprises polyarginine and glycine.

The various compounds in the artifact preventing composition may also have any characteristic that allows them to prevent artifacts in tissue samples that have been fixed with an aldehyde-based fixative. For instance, the compounds (e.g., one or more polyamines and/or Schiff-base-forming compounds) may have a variety of different functional groups, number of residues, molecular weight, chemical subgroups, etc.

The artifact preventing composition may also comprise any other element or chemical that allows the composition to prevent artifacts in tissue samples that have been fixed with an aldehyde-based fixative. For example, the composition may comprise water and/or one or more buffers, alcohols, solvents (e.g., water or DMSO), pH regulators, detergents, tissue stains, etc.

The compounds in the final solution of the artifact preventing composition, or the final solution of the composition that is used to treat a fixed tissue sample, may have any concentration or combination of concentrations that allows the composition to prevent artifacts in tissue samples that have been fixed with an aldehyde-based fixative. For example, the final solution of the composition may comprise any suitable concentration of polyamines. In some embodiments where the composition comprises one or more polyamines, the concentration of one or more of the polyamines in the final solution of the composition is from about 2% to about 1×10⁻¹⁰%, by weight. In other embodiments, the concentration of each polyamine in the final solution of the composition is from about 1×10⁻⁴% to about 1×10⁻⁸%, by weight. In still other embodiments, the concentration of each polyamine in the final solution of the composition is between about 1×10⁻⁶% and about 8.3×10⁻⁷%, by weight. For instance, although the final solution of the artifact preventing composition may comprise different concentrations of different polyamines, in some cases the final solution comprises polyamines (e.g., polylysine and polyarginine) at a final concentration of about 3.3×10⁻⁷%, by weight.

In another example, the final solution of the artifact preventing composition may comprise any suitable concentration of Schiff-base-forming compounds. In some embodiments where the composition comprises one or more Schiff-base-forming compounds, the concentration of one or more of the Schiff-base-forming compounds in the final solution is from about 1×10⁻²% to about 1×10⁻¹⁰%, by weight. In other embodiments, the concentration of each Schiff-base-forming compound in the final solution is from about 1×10⁻⁴% to about 1×10⁻⁸%, by weight. In still other embodiments, the concentration of each Schiff-base-forming compound in the final solution is from about 1×10⁻⁵% to about 9.9×10⁻⁷%, by weight. In some preferred embodiments, the Schiff-base-forming compounds are present in the final solution at a concentration between about 1×10⁻⁷% and about 9.9×10⁻⁷%, by weight. Although the final solution of the artifact preventing composition may comprise multiple Schiff-base-forming compounds with approximately the same concentration, in some cases, the final solution of the composition comprises one Schiff-base-forming compound (e.g., aspartic acid) at a concentration of about 3'10⁻⁶%, another Schiff-base-forming compound (e.g., glycine) at a concentration of about 3×10⁻⁵%, and yet another Schiff-base-forming compound (e.g., polyethylenimine) at a concentration of about 3×10⁻⁷%, by weight.

The final solution of the composition may be made in any suitable manner that gives the solution a sufficient concentration of polyamines and/or Schiff-base-forming compounds to prevent artifacts associated with an aldehyde-based fixative. For example, the artifact preventing composition may be produced and distributed at a final concentration or as a concentrated stock solution that can then be diluted to form the final solution. Indeed, because it may be beneficial to begin with low concentrations of the artifact preventing composition and then increase the concentrations until the desired results are obtained, in some embodiments, a concentrated stock solution may be preferred. In such embodiments, the stock solution may have any suitable concentration of aldehyde-reactive compounds. Additionally, the concentration of the various aldehyde-reactive compounds may vary from one sample to another, depending on factors such as tissue thickness, tissue type, the temperature, the duration of processing time, etc.

The concentrated stock solution may be added to a solvent (e.g., water, alcohol, a tissue stain solution, etc.) to form a final solution of the composition in any suitable manner. For example, the stock solution may be added to a solvent by means of a micropipette, a dropper, a graduated cylinder, etc. In some embodiments, however, it may be beneficial to dilute the stock solution into the solvent drop wise. For example, where the stock solution comprises about 0.02% polylysine, about 0.02% polyarginine, about 0.01% asparagine, about 0.1% glycine, and about 0.001% polyethylenimine, 1 drop (between about 40 and about 50 micro-liters) of the stock solution may be added to approximately 600 milliliters of solvent. Additional drops of the stock solution may then be added to the solvent until the desired results are obtained in the tissue sample. For instance, 2, 3, 4, 5, or more drops may be added to the 600 milliliters of solvent. Indeed, one of skill in the art will recognize that tissue types, fixation methods, tissue stains, tissue thicknesses, and so forth may vary widely between applications and laboratories.

A fixed tissue sample may be treated with the artifact preventing composition at any time that allows the composition to prevent artifacts. For example, after a tissue sample has been fixed but before the sample has been stained, it may be contacted with the composition. In another example, the sample may be contacted with a stain and the composition after the sample has been fixed. In this example, the composition may be contacted with the sample at any appropriate time during the staining process. For instance, the composition may be combined with the tissue stain to form a solution that may be contacted with the tissue sample. However, in other instances, the stain may be contacted with the tissue sample and then the composition may be added to the stain solution surrounding the sample.

Indeed, in some embodiments, it may be beneficial to treat the sample with the artifact preventing composition during the staining process. For instance, some tissue stains may compete with the aldehyde-based fixative for binding sites in the tissue and, thereby, act to prevent artifacts. Similarly, some stains may reverse the methylene bridges formed by an aldehyde-based fixative so as to release the fixative into solution and increase the amount of fixative that binds to or otherwise reacts with the polyamines and/or Schiff-base-forming compounds in the artifact preventing composition. In some instances, the addition of the artifact preventing composition during the staining process may also act to improve staining by modifying the binding sites in the tissue sample. For example, the artifact preventing composition may act to modify binding sites in histone tails, which may increase the amount of stain that binds to such sites.

In other embodiments, it may be beneficial to contact the tissue sample with the artifact preventing composition after the tissue sample has been both fixed and stained. In one example, the sample may be fixed and stained with a first stain before being contacted with a second stain solution that contains the artifact preventing composition. For instance, after the sample has been fixed and stained with a hematoxylin stain, the sample may be contacted with an eosin stain solution containing the artifact preventing composition. In another example, the tissue sample may be treated with the artifact preventing composition long after the sample has been both fixed and stained. For instance, a tissue sample that was fixed, stained, and then put in storage, may be removed from storage and then be treated with the artifact preventing composition to reduce, reverse, or otherwise prevent artifacts in the tissue.

The artifact preventing composition can be used with any tissue stain or any number of stains that allow the composition to prevent artifacts in a tissue sample that has been fixed with an aldehyde-based fixative. For example, the composition can be used on tissue samples that are stained with a simple stain, including, but not limited to, hematoxylin and/or eosin. Some additional examples of suitable simple stains may include acridine orange, bismark brown, carmine, coomassi blue, crystal violet, DAPI, ethidium bromide, fuchsin, Hoechst stain, rodine, malachite green, methyl green, methylene blue, neutral red, nile blue, nile red, osmium tetroxide, rhodamine, safanin, etc. In another example, the composition can be used on samples that are stained with complex stains, such as immunoperoxidase, alkaline phosphatase, and/or immunofluorescence. For instance, the composition could be used on a tissue sample that has been stained with one or more fluorophores, such as green fluorescent protein. In such instances, the tissue sample can be stained with any suitable number of fluorophores, such as 2, 5, 10, 20 30, or more. In still another non-limiting example, the composition may be used to prevent artifacts in a tissue sample that has been stained during in situ hybridizations or with coomassie blue.

The artifact preventing composition may be added to a fixed tissue sample in any way that allows the composition to prevent artifacts in the sample. For example, a fixed tissue sample may be immersed with, sprayed with, rinsed with, or otherwise contacted with the artifact preventing composition. In some embodiments, it may be beneficial to immerse the sample in a final solution of the composition containing a proper concentration of one or more of the aldehyde-reactive compounds and other desired substances.

After being contacted with a tissue sample, a final solution of the artifact preventing composition may be left in contact with the sample for any period of time sufficient to prevent artifacts associated with aldehyde-based fixatives. For example, the sample may be left in contact with the composition for a period as short as a few seconds or as long as several days. For instance, a final solution of the composition may be left in contact with a fixed tissue sample for less than about 25 minutes. However, in other instances, a fixed tissue may be contacted with a final solution of the composition for a period of time between about 10 seconds and about 5 minutes. In yet other instances, a tissue sample may be left in contact with the composition between about 2.5 minutes and about 3 minutes.

Once the tissue has been contacted with the artifact preventing composition, the polyamines and/or Schiff-base-forming compounds from the composition can be removed from the sample though any method or technique known in the art. For example, the polyamines and/or Schiff-base-forming compounds of the composition as well as any reacted aldehyde-based fixative may be removed from a tissue sample by rinsing the sample, washing the sample in a series of baths, and so forth. In this manner, released aldehyde-based fixative may be removed from a tissue sample to prevent the released fixative from causing addition artifacts in the sample.

Using one or more polyamines and/or Schiff-base-forming compounds to bind to or otherwise react with aldehyde-based fixative that has been released into solution may offer several advantages. For example, treating a fixed sample with the described artifact preventing composition may serve to allow more stain to bind to polar amino acids and similar residues in the tissue sample. Accordingly, the artifact preventing composition may improve tissue staining and increase staining intensity. Similarly, treatment with the described composition may reduce the amount of aldehyde-based fixative pigment in a tissue sample. The composition may also serve to restore immunoreactivity to a tissue fixed with an aldehyde-based fixative and, thereby, increase the ability to stain the tissue immunohistochemically. Additionally, the composition may serve to capture aldehyde-based fixative that has been released into solution through prolonged exposure to a stain, such as hematoxylin. Thus, the composition may prevent the formation of additional artifacts. Moreover, the artifact preventing composition may return cells and cell structures to their pre-fixation size and shape. In this manner, the composition may improve tissue morphology and staining features.

Additionally, mixing the artifact preventing composition with a tissue stain (e.g., hematoxylin, eosin, etc.) may offer several advantages. In one example of an unexpected advantage associated with mixing the composition with a tissue stain, the composition may act to increase the tissue stain's useful shelf-life. For instance, where a stain solution without the artifact preventing composition may only last a few days (e.g., a week) at room temperature and without bacterial contamination, before it begins to precipitate or otherwise lose its reactivity. The same tissue stain solution with the artifact preventing composition may last 2, 3, 4, 5, 6, 7, 8, or more times longer without precipitating and without unduly decreasing in reactivity. In one non-limiting example, where a stain solution without the artifact preventing composition has a useful shelf life of about 7 days, the shelf-life of the tissue stain may be increased by period selected from about 6 to about 8 weeks. This extended shelf-life may be achieved by adding the artifact preventing composition 1 time, or 2, 3, 4, or more times, as the effectiveness of the composition is depleted. Of course, the amount of time by which a tissue stain's shelf-life is increased by the artifact preventing composition may vary depending on a number of factors, such as stain used, tissue thickness, tissue type, fixation method, concentration of the artifact preventing composition, the number of times the composition is added to the stain, etc.

### Examples

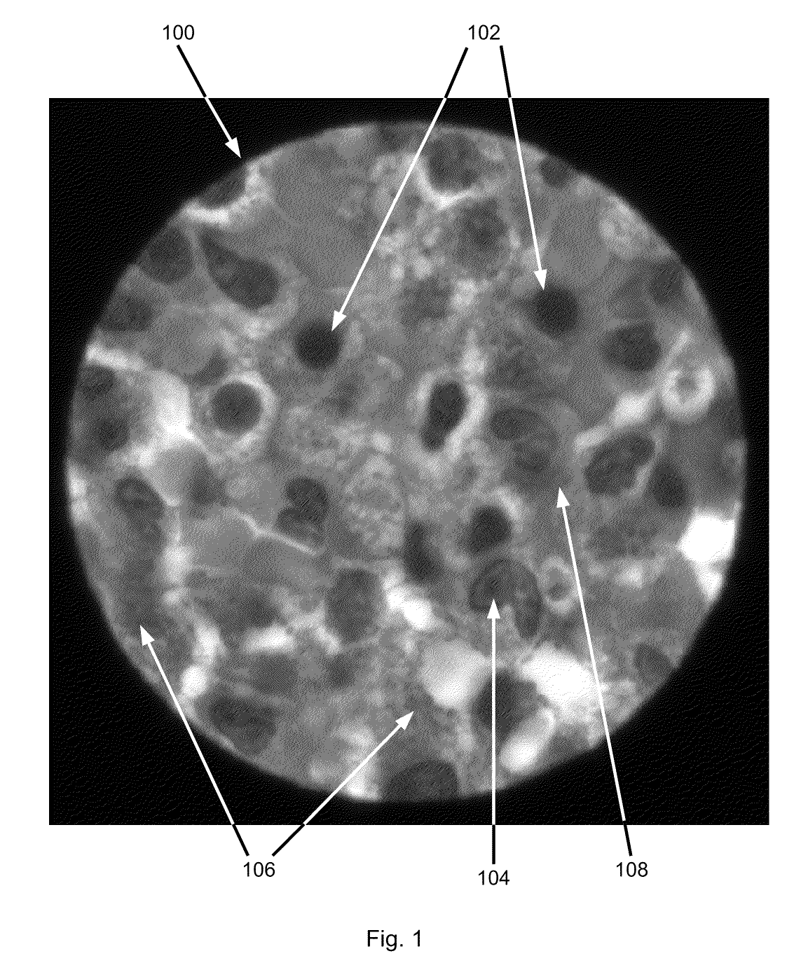

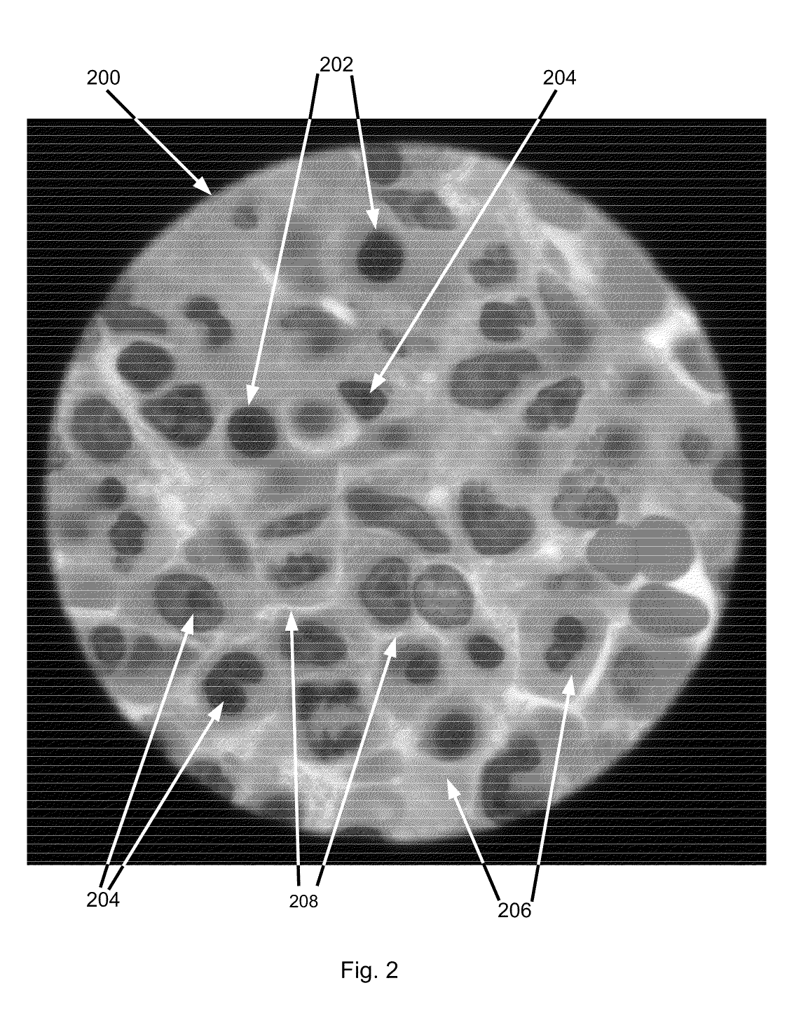

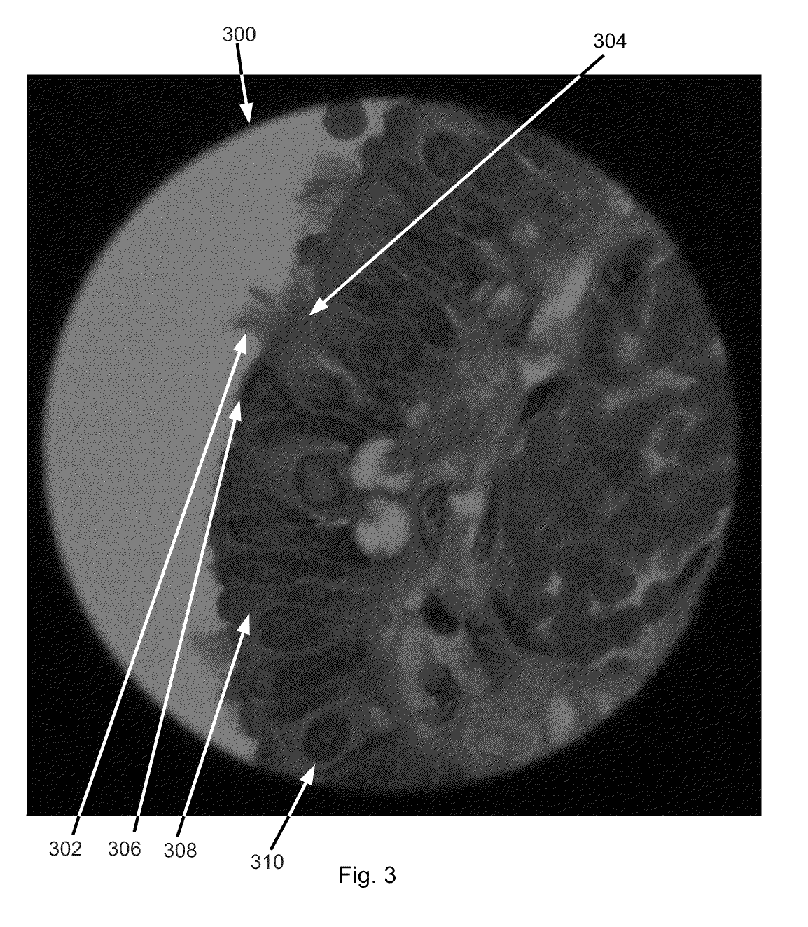

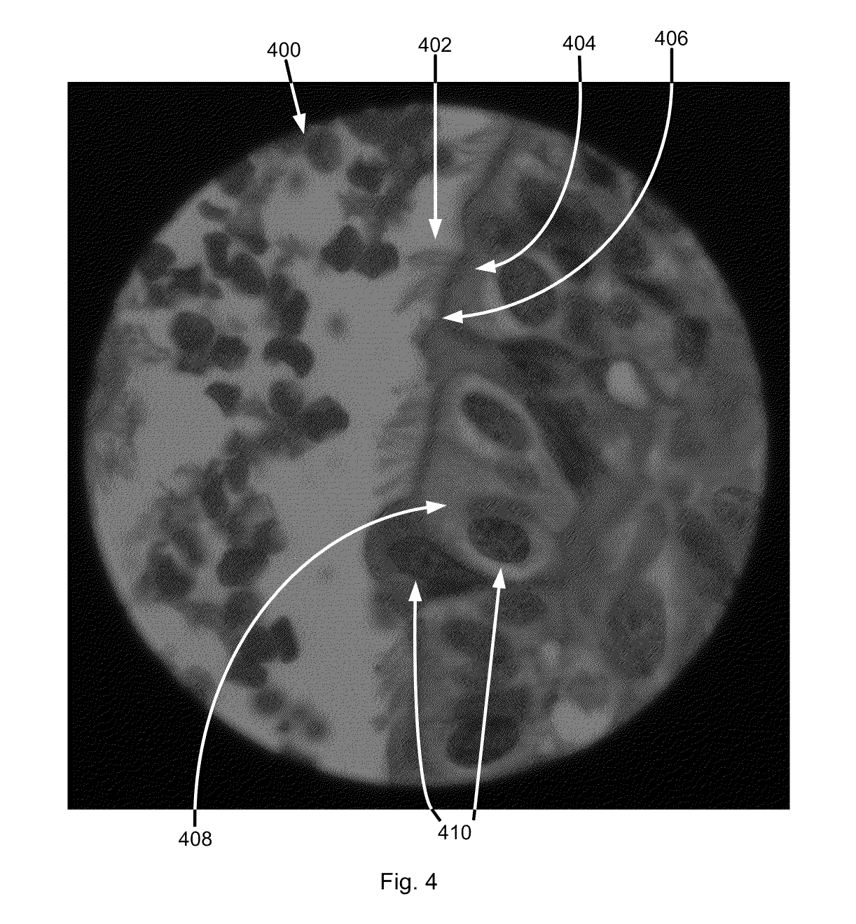

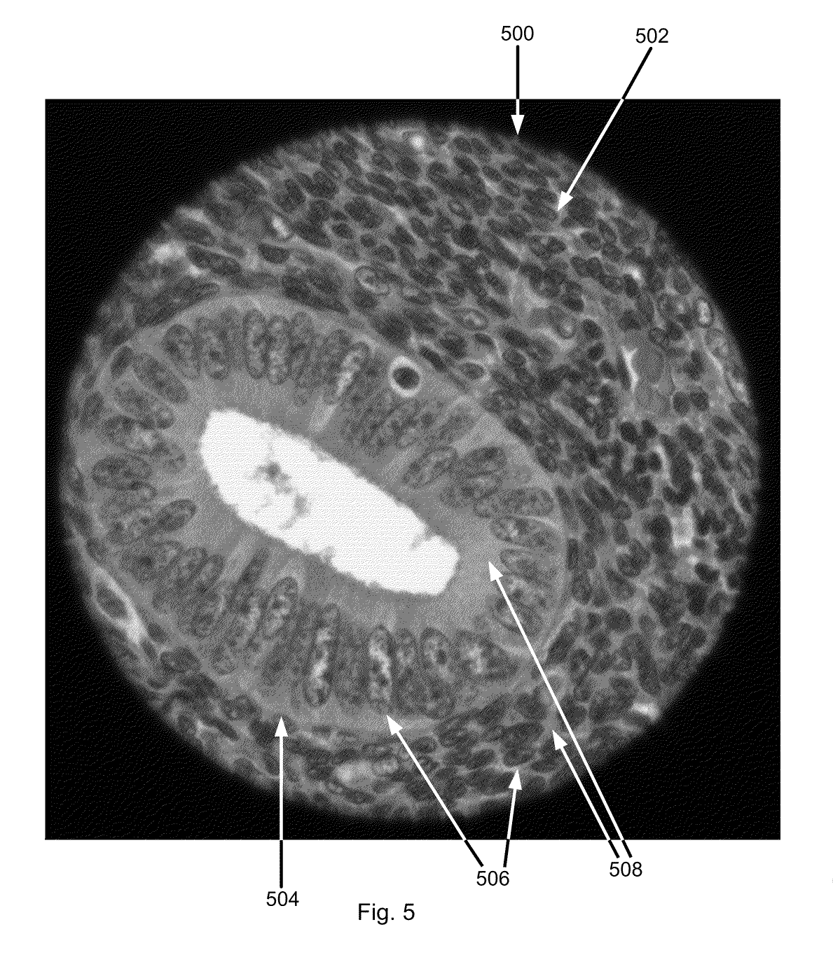

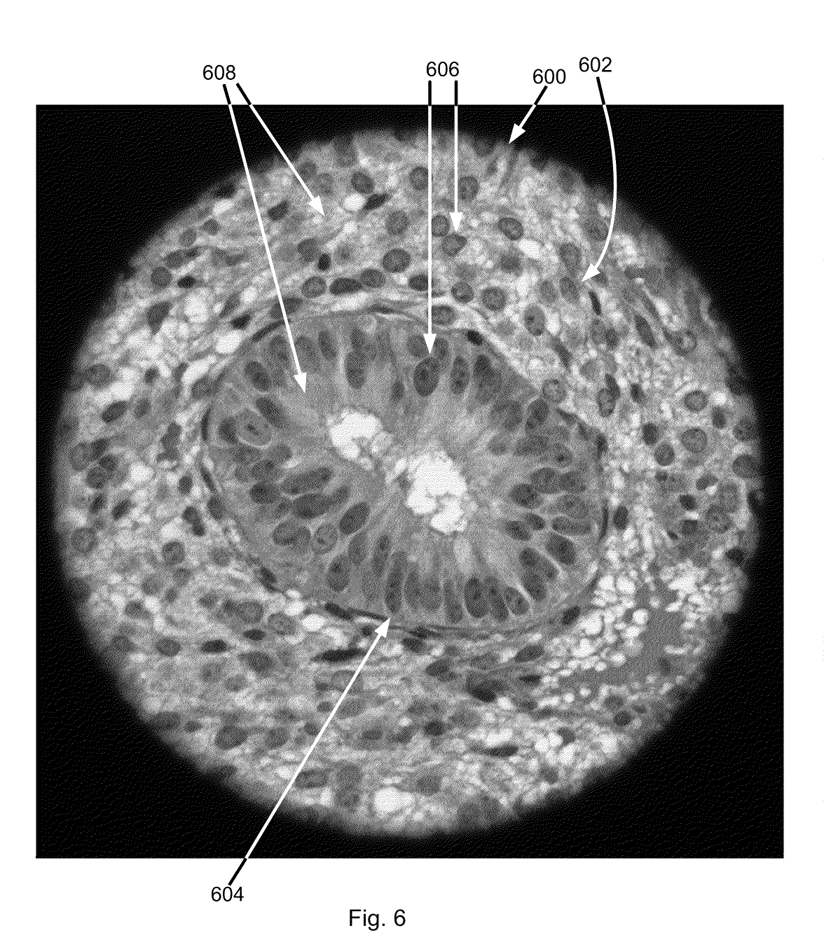

The Figures provided with the present disclosure include comparative images of three different types of fixed and stained human tissue samples. In particular, FIGS. 1 and 2 contain images of human bone marrow tissue, FIGS. 3 and 4 contain images of human uterine tube tissue, and FIGS. 5 and 6 contain images of human endometrial tissue. In each of the Figures, the samples were prepared using similar fixative media and techniques. For example, in FIGS. 1 through 6 the tissue samples were fixed with fixative agent that is about 5% formalin. Moreover, the samples in FIGS. 1 through 6 were each stained using similar processes and compositions. For instance, the samples in FIGS. 1 through 6 were each stained with hematoxylin, which targets histone end terminal tails (in the nucleus), and eosin, which targets proteins (in the cytoplasm). Additionally each of the photographs was taken with a LEICA® light microscope at a magnification of 1250×.

Although the samples in FIGS. 1 through 6 were fixed and stained in virtually the same manner, only half of the samples were treated with the artifact preventing composition. Specifically, while the samples in FIGS. 2, 4, and 6 were treated with the artifact preventing composition, the samples in FIGS. 1, 3, and 5 were not. To better illustrate the effectiveness of the artifact preventing composition, the various tissue samples that were not treated with the artifact preventing composition, or the untreated samples, are compared with corresponding treated tissue samples, or tissue samples that were treated with the composition.

In one comparative example, FIGS. 1 and 2 illustrate that the untreated bone marrow tissue sample 100 in FIG. 1 has several artifacts that are reduced or not present in the treated sample 200 shown in FIG. 2. For instance, while the boarders of the nuclei 102 in the sample of FIG. 1 tend to be blurry and not well defined, the nuclei 202 in the sample of FIG. 2 tend to be clear and well defined. Moreover, in FIG. 2, the nucleoli 204 appear to be better defined and more apparent than the nucleoli 104 in FIG. 1.

Additionally, the cytoplasm 106 in FIG. 1 has appears to have vacuole artifacts in which the cytoplasm 106 is filled with small bubbles that give the cytoplasm 106 a marbled appearance and prevent it from being well defined. In contrast, the cytoplasm 206 in FIG. 2 appears to be free from any significant cytoplasmic vacuolation. Accordingly, the cytoplasm 206 in FIG. 2 appears to be smooth and to have cytoplasmic borders 208 that are better defined than the cytoplasmic borders 108 in FIG. 1.

In another comparative example, FIGS. 3 and 4 show that the untreated uterine tube tissue sample 300 in FIG. 3 has several artifacts that are reduced or not present in the treated uterine tube tissue sample 400 in FIG. 4. For instance, a comparison of the samples 300 and 400 in FIGS. 3 and 4 shows that the cilia 402 in the treated sample 400 in FIG. 4 appears to be better defined than the cilia 302 in the untreated sample 300 in FIG. 3. Similarly, the cilia anchoring 404 through the cellular membrane 406 in FIG. 4 appears to be more visible and defined than the cilia anchoring 304 in FIG. 3. Additionally, the cytoplasm 408 and nuclei 410 in the treated sample 400 of FIG. 4 appear to be clearer and better defined than the cytoplasm 308 and nuclei 310 of the untreated sample in FIG. 3.

In a final comparative example, FIGS. 5 and 6 illustrated that the untreated endometrial tissue sample 500 in FIG. 5 has several artifacts that are reduced or not present in the treated endometrial tissue sample 600 in FIG. 6. For instance, the stromal cells 502 and endometrial tubular gland cells 504 in FIG. 5 appear to be significantly more compacted together than do the stromal cells 602 and endometrial tubular gland cells 604 in FIG. 6. Similarly, the nuclei 606 and cytoplasm 608 in the treated sample 600 (FIG. 6) appear to be better defined than, and include fine features that are not found in, the nuclei 506 and cytoplasm 508 in the untreated sample 500 of FIG. 5.

In short, a comparison of the untreated samples in FIGS. 1, 3, and 5 against the treated samples in FIGS. 2, 4, and 6 shows that the addition of the artifact preventing composition to the samples in FIGS. 2, 4, and 6 may greatly reduce artifacts in the fixed and stained tissue samples.

The present methods and compositions may be embodied in other specific forms without departing from its structures, methods, or other essential characteristics as broadly described herein and claimed hereinafter. The described examples and embodiments are to be considered in all respects only as illustrative, and not restrictive. The scope of the invention is, therefore, indicated by the appended claims, rather than by the forgoing description. All changes that come within the meaning and range of equivalency of the claims are to be embraced within their scope.

1. A method for preventing fixative artifacts in tissue samples fixed with an aldehyde-based fixative, the method comprising:
obtaining a tissue sample fixed with an aldehyde-based fixative agent;
contacting the tissue sample with an artifact preventing composition that reacts with free aldehyde-based fixative agent to prevent artifact formation; and
contacting the tissue sample with a tissue stain.

2. The method according to claim 1, wherein the artifact preventing composition comprises a polyamine.

3. The method according to claim 2, wherein the artifact preventing composition comprises a Schiff-base-forming compound.

4. The method according to claim 2, wherein the polyamine is selected from a polymer comprising arginine, polyarginine, lysine, polylysine, putrescine, polyethylene amine, tryptophene, polytryptophene, cadaverine, spermidine, spermine, and combinations thereof.

5. The method according to claim 3, wherein the Schiff-base-forming compound is selected from glycine; arginine; aspartic acid; a peptide comprising glycine, arginine, or aspartic acid; polyethylenimine; and combinations thereof.

6. The method according to claim 1, wherein the aldehyde-based fixative agent comprises formaldehyde.

7. The method according to claim 2, wherein the polyamine is contacted with the tissue sample at a concentration selected from:
a. between about 1×10⁻²% and about 1×10⁻¹⁰%, by weight;
b. between about 1×10⁻⁴% and about 1×10⁻⁸%, by weight;
c. between about 1×10⁻⁶% and about 8.3×10⁻⁷%, by weight;
d. about 3.3×10⁻⁷%, by weight.

8. The method according to claim 3, wherein the Schiff-base-forming compound is present in a final solution at a concentration selected from:
a. between about 1×10⁻²% and about 1×10⁻¹⁰%, by weight;
b. between about 1×10⁻⁴% and about 1×10⁻⁸%, by weight;
c. between about 1×10⁻⁵% and about 9×10⁻⁷%, by weight; and
d. between about 1×10⁻⁷% and about 9.9×10⁻⁷%, by weight.

9. The method according to claim 1, wherein the tissue stain is selected from a simple tissue stain or a complex tissue stain.

10. The method according to claim 9, wherein the tissue stain is selected from immunoperoxidase, a fluorophore, hematoxylin, eosin, and combinations thereof.

11. The method according to claim 1, wherein the tissue stain and the artifact preventing composition are combined together before contacting the tissue sample.

12. An artifact preventing composition that prevents artifacts in tissue samples fixed with an aldehyde-based fixative, the composition comprising a polyamine with a final concentration between about 1×10⁻²% and about 1×10⁻¹⁰%, by weight.

13. The composition according to claim 12, further comprising a Schiff-base-forming compound.

14. The composition according to claim 12, wherein the polyamine is selected from a polymer comprising arginine, polyarginine, lysine, polylysine, putrescine, polyethylene amine, tryptophene, polytryptophene, cadaverine, spermidine, spermine, and combinations thereof.

15. The composition according to claim 12, wherein the artifact preventing composition further comprises a tissue stain.

16. The composition according to claim 13, wherein the Schiff-base-forming compound is selected from glycine; arginine; aspartic acid; polyethylenimine; a peptide comprising glycine, arginine, or aspartic acid; polyethylenimine; and combinations thereof.

17. The composition according to claim 16, wherein the Schiff-base-forming compound comprises glycine.

18. The composition according to claim 12, wherein a final solution of the composition comprises the polyamine at a final concentration selected from:
a. between about 1×10⁻⁴% and about 1×10⁻⁸%, by weight;
b. between about 1×10⁻⁶% and about 8.3×10⁻⁷%, by weight; and
c. about 3.3×10⁻⁷%, by weight.

19. The composition according to claim 13, wherein a final solution of the composition comprises the Schiff-base-forming compound at a final concentration selected from:
a. between about 1×10⁻²% and about 1×10⁻¹⁰%, by weight;
b. between about 1×10⁻⁴% and about 1×10⁻⁸%, by weight;
c. between about 1×10⁻⁵% and about 9×10⁻⁷%, by weight; and
d. between about 1×10⁻⁷% and about 9.9×10⁻⁷%, by weight

20. A method for increasing the active shelf-life of a tissue stain, the method comprising:
providing a tissue stain; and
adding an artifact preventing composition comprising a polyamine to the tissue stain.

21. The method of claim 20, wherein the artifact preventing composition further comprises a Schiff-base-forming compound.

22. The method of claim 20, wherein the tissue stain is selected from immunoperoxidase, a fluorophore, hematoxylin, eosin, and combinations thereof.

23. The method of claim 20, wherein the polyamine is selected from a polymer comprising arginine, polyarginine, lysine, polylysine, putrescine, polyethylene amine, tryptophene, polytryptophene, cadaverine, spermidine, spermine, and combinations thereof.

24. The method of claim 21, wherein the Schiff-base-forming compound is selected from glycine; arginine; aspartic acid; polyethylenimine; a peptide comprising glycine, arginine, or aspartic acid; polyethylenimine; and combinations thereof.
